(19) United States
(12) Patent Application Publication
(10) Pub. No.: US 2022/0189462 A1
(43) Pub. Date: Jun. 16, 2022

(54) METHOD OF TRAINING A SPEECH RECOGNITION MODEL OF AN EXTENDED LANGUAGE BY SPEECH IN A SOURCE LANGUAGE

(71) Applicant: NATIONAL CHENG KUNG UNIVERSITY, Tainan City (TW)

(72) Inventors: Wen-Hsiang LU, Tainan City (TW); Shao-Chuan SHEN, Taipei City (TW); Ching-Jui LIN, Kaohsiung City (TW)

(73) Assignee: NATIONAL CHENG KUNG UNIVERSITY, Tainan City (TW)

(21) Appl. No.: 17/462,776

(22) Filed: Aug. 31, 2021

(30) Foreign Application Priority Data
Dec. 10, 2020 (TW) 109143725

(51) Int. Cl. G10L 15/06; G10L 15/187

(52) U.S. Cl. CPC G10L 15/063; G10L 15/187

(57) ABSTRACT

A method of training a speech recognition model of an extended language by speech in a source language includes the following steps: creating a phonetic reference table of the source language, wherein the phonetic reference table includes a source language audio file and a source language phonetic transcription corresponding to each other; obtaining an extended language text file of the extended language; marking the extended language text file with an extended language phonetic transcription to create a text reference table of the extended language; training an acoustic model of the extended language by the phonetic reference table and the text reference table; and training a language model of the extended language by the extended language text file of the extended language; wherein the speech recognition model of the extended language includes the acoustic model and the language model of the extended language.

### CROSS-REFERENCE TO RELATED APPLICATIONS

This non-provisional application claims priority under 35 U.S.C. § 119(a) on Patent Application No(s). 109143725 filed in Taiwan, R.O.C. on Dec. 10, 2020, the entire contents of which are hereby incorporated by reference.

### TECHNICAL FIELD

The present disclosure relates to a method of training a speech recognition model, and more particularly to a method of training a speech recognition model of an extended language by speech in a source language.

### BACKGROUND

As technology develops, voice user interfaces are added to electronic products so that users can perform tasks other than operating the electronic products with their hands.

For performing the voice user interfaces, a speech recognition system should be built in the electronic products. However, in order to accurately recognize different pronunciation frequencies, speech tempos or intonations of the users, multiple sets of pronunciation should be stored in the speech recognition system. For example, for an accurate recognition of a sentence of “Nĭ Haŏ” (meaning: hello), the speech recognition system should store pronunciation records of multiple Standard Mandarin speakers. Therefore, during the development of a new speech recognition system for a language, a lot of human resources and costs must be spent in the early stage to collect pronunciation records of multiple speakers in this language, and then these pronunciation records need to be organized so as to be used as the corpus for developing the new speech recognition system. Moreover, the difficulty of developing the new speech recognition system will be increased if the speech recognition system to be developed belongs to a language with a small number of speakers.

### SUMMARY

The present disclosure provides a method of training a speech recognition model of an extended language by speech in a source language, which may eliminate or significantly simplify the step of collecting the corpus of the extended language while developing a new speech recognition model.

According to one aspect of the present disclosure, a method of training a speech recognition model of an extended language by speech in a source language includes the following steps: creating a phonetic reference table of the source language, wherein the phonetic reference table comprises a source language audio file and a source language phonetic transcription that correspond to each other; obtaining an extended language text file of the extended language; according to a mark instruction, marking the extended language text file with an extended language phonetic transcription so as to create a text reference table of the extended language; training an acoustic model of the extended language by the phonetic reference table of the source language and the text reference table of the extended language; and training a language model of the extended language by the extended language text file of the extended language; wherein the speech recognition model of the extended language comprises the acoustic model and the language model of the extended language.

In view of the above statement, the speech recognition model of the extended language can be trained by a speech corpus of the source language without collecting speech of the extended language. Accordingly, the acoustic model of the source language can be used for the extended language, especially for a language with a small number of speakers, at low cost by transfer learning, which may simplify the training process and reduce the training cost, so that the speech recognition model of the extended language can be trained quickly and easily.

### BRIEF DESCRIPTION OF THE DRAWINGS

The present disclosure will become more fully understood from the detailed description given hereinbelow and the accompanying drawings which are given by way of illustration only and thus are not intending to limit the present disclosure and wherein:

FIG. 1 is a block diagram of an electronic device applying a method of training a speech recognition model of an extended language by speech in a source language according to one embodiment of the present disclosure;

FIG. 2 is a flow chart of the method of training the speech recognition model of the extended language by speech in the source language in FIG. 1;

FIG. 3 is a partial detailed flow chart of the method of training the speech recognition model of the extended language by speech in the source language in FIG. 2;

FIG. 4A and FIG. 4B are partial detailed flow charts of the method of training the speech recognition model of the extended language by speech in the source language in FIG. 3;

FIG. 5 is a partial detailed flow chart of the method of training the speech recognition model of the extended language by speech in the source language in FIG. 2;

FIG. 6 is a partial detailed flow chart of a method of training a speech recognition model of an extended language by speech in a source language according to another embodiment of the present disclosure;

FIG. 7 is a partial detailed flow chart of a method of training a speech recognition model of an extended language by speech in a source language according to further another embodiment of the present disclosure; and

FIG. 8 is a partial detailed flow chart of a method of training a speech recognition model of an extended language by speech in a source language according to still further another embodiment of the present disclosure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

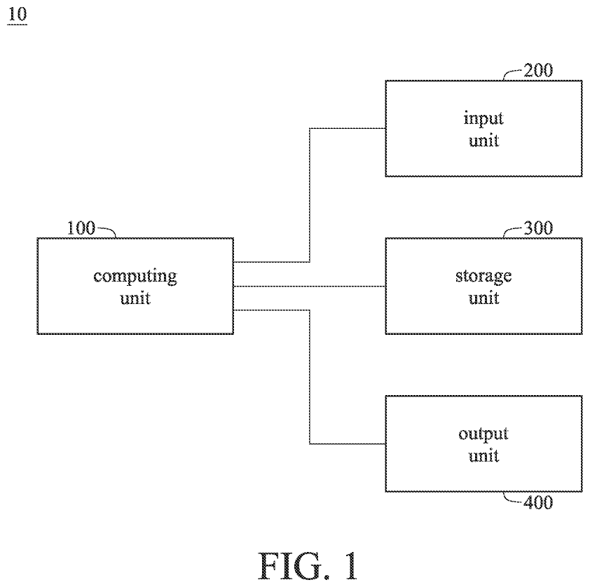

This embodiment provides a method of training a speech recognition model of an extended language by speech in a source language, and the speech recognition model can be applied to an electronic device. The electronic device will be described first. Please refer to FIG. 1, which is a block diagram of the electronic device 10 applying the method of training the speech recognition model of the extended language by speech in the source language according to one embodiment of the present disclosure.

The electronic device 10 (e.g., a computer) is configured for training the speech recognition model, such that the electronic device 10 can therefore become a speech recognition system or create a speech recognition system which is able to be outputted and applied to another electronic product. Specifically, the electronic device 10 may include a computing unit 100, an input unit 200, a storage unit 300 and an output unit 400. The computing unit 100 may be a central processing unit (CPU). The input unit 200 may be a microphone, a keyboard, a mouse, a touch screen or a transmission interface and is electrically connected to the computing unit 100. The storage unit 300 may be a hard disk drive and is electrically connected to the computing unit 100. The output unit 400 may be a speaker or a displayer and is electrically connected to the computing unit 100.

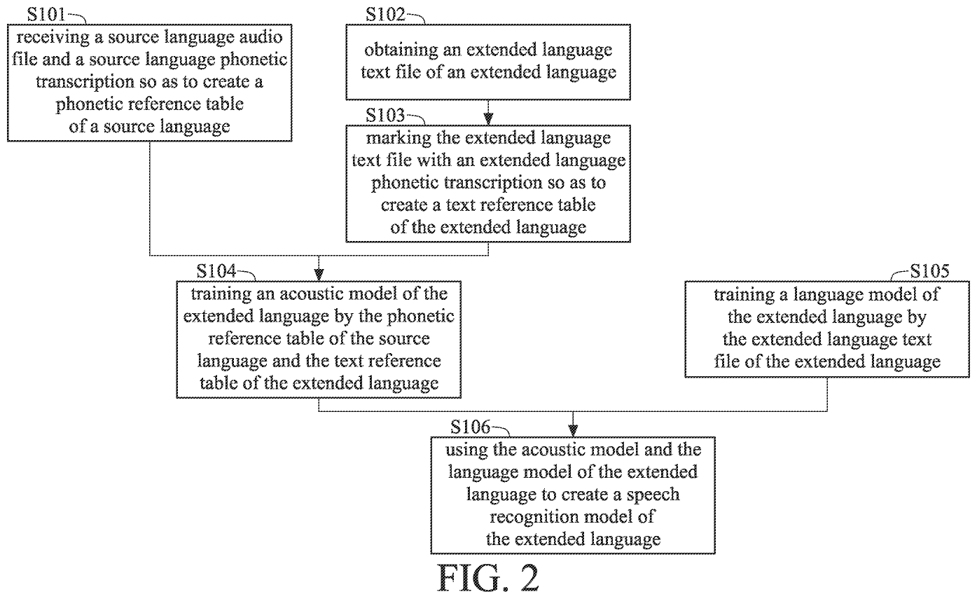

In the following, the method of training the speech recognition model applied to the electronic device 10 will be described. Please refer to FIG. 2, which is a flow chart of the method of training the speech recognition model of the extended language by speech in the source language in FIG. 1.

In the present disclosure, there is a source language audio file that may include a completely established pronunciation recoding file of multiple people from a widely used language. In addition, there is also a source language phonetic transcription that may include vowel and consonant phonetic symbols from the widely used language based on Roman script. The widely used language may be Standard Mandarin, Modern English, South Korean Standard Language, etc. and will be called a source language hereinafter.

In this embodiment, in step S101, the input unit 200 receives the source language audio file and the source language phonetic transcription, such that the computing unit 100 is able to create a phonetic reference table of the source language in the storage unit 300, wherein the phonetic reference table of the source language includes the source language audio file and the source language phonetic transcription. The source language phonetic transcription may include a sequence of Roman script used for representing the source language audio file. For example, vowel and consonant symbols of “jin-tian-hao-tian-chi” are used to represent speech in a record of a meaning of “the weather is good today” from Standard Mandarin, without tone letters. The sequence of Roman script may be directly acquired from an organized speech recognition system of the source language or created by the computing unit 100, and the present disclosure is not limited thereto.

In step S102, the input unit 200 obtains an extended language text file of the extended language. The extended language is the language to which the speech recognition model to be created belongs, such as Taiwanese Hokkien, Taiwanese Hakka, Spanish,

Japanese or Thai. The extended language text file may include articles composed of a commonly used vocabulary from the extended language.

In step S103, the input unit 200 receives a mark instruction, such that the computing unit 100 is able to mark the extended language text file with an extended language phonetic transcription so as to create a text reference table of the extended language in the storage unit 300. The mark instruction may be generated by an image recognition system (not shown). The extended language phonetic transcription may include a sequence of Roman script used for representing the extended language text file. For example, vowel and consonant symbols of “kin-a-jit-ho-thinn” are used to represent text in a sentence of a meaning of “the weather is good today” from Taiwanese Hokkien, without tone letters.

In step S104, the computing unit 100 trains an acoustic model of the extended language by the phonetic reference table of the source language and the text reference table of the extended language. The acoustic model can be regarded as including the probability that speech in a record belongs to one or more specific phoneme sequences and the probability that the one or more specific phoneme sequences correspond to one or more specific symbol sequences in a language.

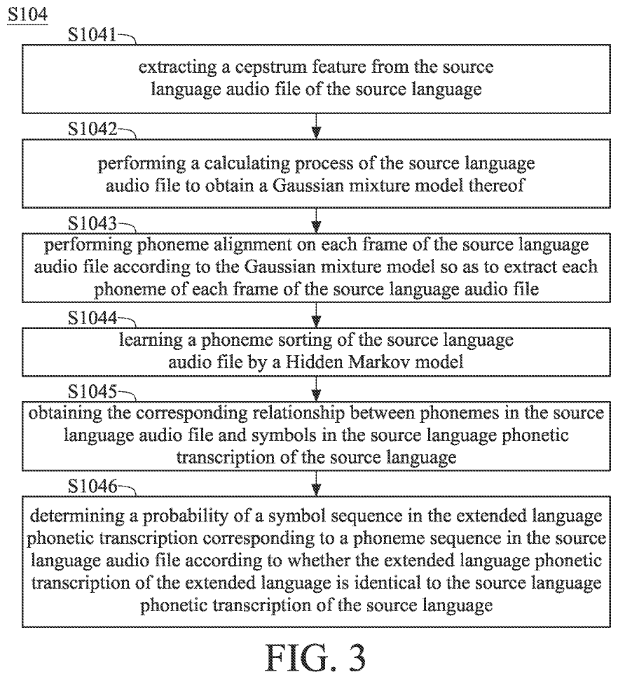

Specifically, please refer to FIG. 3, which is a partial detailed flow chart of the method of training the speech recognition model of the extended language by speech in the source language in FIG. 2. In this and some embodiments, in step S1041, the computing unit 100 extracts a cepstrum feature from the source language audio file of the source language. In step S1042, the computing unit 100 performs a calculating process by each three frames of the source language audio file to obtain a Gaussian mixture model thereof, wherein each frame refers to 20 milliseconds. In step S1043, the computing unit 100 performs phoneme alignment on each frame of the source language audio file according to the Gaussian mixture model so as to extract each phoneme of each frame of the source language audio file. In step S1044, the computing unit 100 learns a phoneme sorting of the source language audio file by a Hidden Markov model. In step S1045, the computing unit 100 obtains the corresponding relationship between phonemes in the source language audio file and symbols in the source language phonetic transcription of the source language. Note that step S1041 to step S1045 are exemplary in training the acoustic model of the extended language and are not intended to limit the present disclosure. In some other embodiments, there may be another model or manner for training the acoustic model of the extended language.

In general, the corresponding relationship between phonemes in the source language audio file and symbols in the source language phonetic transcription should be one-to-one correspondences. However, a language can be Romanized in different ways. For example, a word of a meaning of “concave” from Standard Mandarin can be Romanized as “ao” or “au”. For this situation, the abovementioned corresponding relationship may be changed into one-to-many correspondences. Alternatively, the vowel and consonant symbols used for representing the source language audio file and the extended language text file in the abovementioned steps may be based on International Phonetic Alphabet (IPA) rather than Roman script so as to reduce differences between conversions of writing.

In addition, in some languages, a final consonant (syllable coda) of a word may be linked to a first vowel of a next word during pronunciation. For example, “hold on” from Modern English may be pronounced “hol-don”, and “da-eum-e” (meaning: next time) from

South Korean Standard Language may be pronounced “da-eu-me” or “da-eum-me”. Regarding this, the computing unit 100 can determine a probability that speech in a record from Modern English corresponds to symbols of “hold-on” and “hol-don” or a probability that speech in another record from South Korean Standard Language corresponds to symbols of “da-eum-e”, “da-eu-me” and “da-eum-me” through learning the phoneme sorting of the source language audio file.

In step S1046, the computing unit 100 determines a probability of a symbol sequence in the extended language phonetic transcription corresponding to a phoneme sequence in the source language audio file according to whether the extended language phonetic transcription of the extended language is identical to the source language phonetic transcription of the source language.

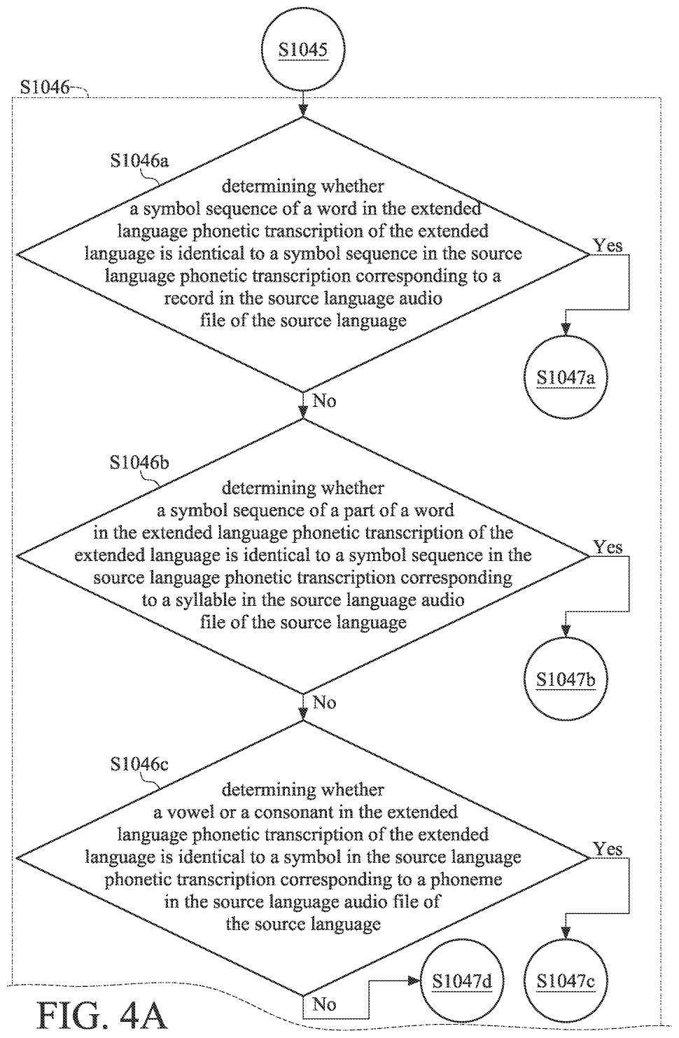

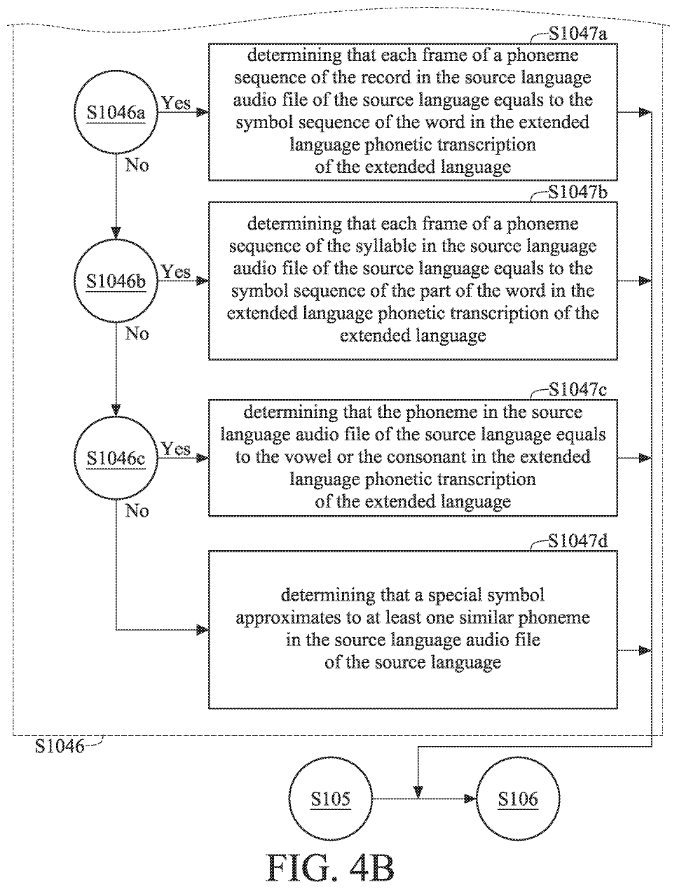

Specifically, please refer to FIG. 4A and FIG. 4B, which are partial detailed flow charts of the method of training the speech recognition model of the extended language by speech in the source language in FIG. 3. In this and some embodiments, in step S1046a, the computing unit 100 determines whether a symbol sequence of a word in the extended language phonetic transcription of the extended language is identical to a symbol sequence in the source language phonetic transcription corresponding to a record in the source language audio file of the source language. For example, the computing unit 100 compares an IPA symbol sequence of “t [symbol] [symbol] ” of a word of “tong-tsing” (meaning: sympathy) from

Taiwanese Hokkien to IPA symbol sequences from Standard Mandarin. When the computing unit 100 determines the word of “tong-tsing” from Taiwanese Hokkien having the same IPA symbol sequence of “t [symbol] [symbol] ” as a word of “dong-jing” (meaning: Tokyo) from Standard Mandarin, this can be considered that the determination in step S1046a is true, and step S1047a is performed. In step S1047a, the computing unit 100 determines that each frame of a phoneme sequence of the record in the source language audio file of the source language equals to the symbol sequence of the word in the extended language phonetic transcription of the extended language. That is, in the abovementioned example, the computing unit 100 determines that a phoneme sequence corresponding to pronunciation of the word of “dong-jing” equals to a symbol sequence of the word of “tong-tsing”. Then, the computing unit 100 outputs an equal relationship between the phoneme sequence of the record (i.e., “dong-jing”) and the symbol sequence of the word (i.e., “tong-tsing”) to the storage unit 300 to store the equal relationship in the storage unit 300.

After being processed by the above steps, equal relationships for cases of multiple syllables in the extended language phonetic transcription are already determined, and step S1046b is then performed on the remaining extended language phonetic transcription. In step S1046b, the computing unit 100 determines whether a symbol sequence of a part of a word in the extended language phonetic transcription of the extended language is identical to a symbol sequence in the source language phonetic transcription corresponding to a syllable in the source language audio file of the source language. For example, the computing unit 100 compares “tong-” (IPA: t [symbol] ) in the word of “tong-tsing” from Taiwanese Hokkien to IPA symbol sequences from Standard Mandarin. For another example, the computing unit 100 compares “cin-” (IPA: si [symbol] ) in a word of “cinco” (meaning: five) from Spanish to IPA symbol sequences from Modern English. When the computing unit 100 determines “tong-” from Taiwanese Hokkien having the same IPA symbol sequence of “t [symbol] ” as “dong-” from Standard Mandarin, or “cin-” in the word of “cinco” from Spanish having the same IPA sequence of “si [symbol] ” as “sin-” in a word of “single” from Modern English, this can be considered that the determination in step S1046b is true, and step S1047b is performed. In step S1047b, the computing unit 100 determines that each frame of a phoneme sequence of the syllable in the source language audio file of the source language equals to the symbol sequence of the part of the word in the extended language phonetic transcription of the extended language. Then, the computing unit 100 outputs an equal relationship between the phoneme sequence of the syllable (i.e., “dong-” or “sin-”) and the symbol sequence of the part of the word (i.e., “tong-” or “cin-”) to the storage unit 300 to store the equal relationship in the storage unit 300.

After being processed by the above steps, equal relationships for cases of syllables in the extended language phonetic transcription are already determined, and then step S1046c is performed on the remaining extended language phonetic transcription. In step S1046c, the computing unit 100 determines whether a vowel or a consonant in the extended language phonetic transcription of the extended language is identical to a symbol in the source language phonetic transcription corresponding to a phoneme in the source language audio file of the source language. For example, when the computing unit 100 determines that the vowel of “ [symbol] ” in the word of “tong-tsing” from Taiwanese Hokkien is the same as the vowel of “ [symbol] ” in the word of “dong Jing” from Standard Mandarin, or the consonant of “ [symbol] ” in the word of “cinco” from Spanish is the same as the consonant of “ [symbol] ” in the word of “single” from Modern English, this can be considered that the determination in step S1046c is true, and step S1047c is performed. In step S1047c, the computing unit 100 determines that the phoneme in the source language audio file of the source language equals to the vowel or the consonant in the extended language phonetic transcription of the extended language. Then, the computing unit 100 outputs an equal relationship between the phoneme (i.e., “ [symbol] ” or “ [symbol] ” in the source language) and the vowel or the consonant (i.e., “ [symbol] ” or “ [symbol] ” in the extended language) to the storage unit 300 to store the equal relationship in the storage unit 300.

In some cases, the computing unit 100 can create a fuzzy symbol set using a fuzzy reference table obtained by the input unit 200 for the consideration that the speech recognition model may receive a voice record without standard pronunciation in the extended language. The fuzzy reference table may be acquired from the speech recognition model of the source language. The fuzzy symbol set includes multiple groups of symbols with similar pronunciation, such as “ [symbol] ” and “ [symbol] ” forming a fuzzy symbol group. As such, the computing unit 100 is able to determine speech in a sentence of “an-chu-se” (meaning: thank you) from

Taiwanese Hakka having an IPA symbol sequence of “an- [symbol] -se” similar to an IPA symbol sequence of “an- [symbol] -se” of a sentence of “anj -eu-se” (can be pronounced “an-jeu-se”; meaning: please sit down) from South Korean Standard Language. Then, the computing unit 100 outputs approximate relationships among the fuzzy symbol set to the storage unit 300 to store the approximate relationships in the storage unit 300.

In some cases, the fuzzy symbol set may further include a symbol sequence corresponding to the pronunciation where one or more consonants are elided for the consideration that the speech recognition model may receive a voice record without pronunciation in the first consonant (e.g., “h”) or the final consonant (e.g., “r”. “n” or “m”). As such, the computing unit 100 is able to determine speech in a conjunction of “so-shi-te” (meaning: and then) from Japanese pronounced similar to a sentence of “so she tear” (past tense) from Standard English, or to determine speech in a phrase of “ni-au” (meaning: after this year) from Taiwanese Hokkien pronounced similar to a sentence of “ni-hao” (meaning: hello) from Standard Mandarin, or to determine speech in a word of “cha-yen” (meaning: Thai iced milk tea) from Thai pronounced similar to a word of “cha-yeh” (meaning: tea leaf) from Standard Mandarin. Then, the computing unit 100 outputs approximate relationships among the fuzzy symbol set to the storage unit 300 to store the approximate relationships in the storage unit 300.

In some cases, the extended language may have a pronunciation that is not included in the source language, so the computing unit 100 determines that a vowel or a consonant corresponding to this pronunciation in the extended language phonetic transcription of the extended language is different from all of the symbols in the source language phonetic transcription corresponding to a phoneme in the source language audio file of the source language. This vowel or this consonant is called a special symbol hereinafter. For example, a pronunciation of “f” from Taiwanese Hakka is not included in South Korean Standard Language and the symbol of “f” is considered as a special symbol. In step S1047d, the computing unit 100 determines that the special symbol approximates to at least one similar phoneme in the source language audio file of the source language. For example, the computing unit 100 is able to determine the pronunciation of “f” from Taiwanese Hakka approximates to the pronunciation of “p” from South Korean Standard Language. Then, the computing unit 100 outputs a fuzzy phoneme set including a fuzzy relationship between the special phoneme and the at least one similar phoneme to the storage unit 300 to store the fuzzy relationship in the storage unit 300.

The computing unit 100 is able to train the acoustic model of the extended language through the equal, approximate or fuzzy relationships between phonemes of the source language and symbols of the extended language that are stored in the storage unit 300, so that the computing unit 100 is able to determine a probability that speech in each record from the extended language belongs to one or more specific phoneme sequences from the source language and therefore belongs to one or more corresponding specific symbol sequences from the extended language.

Then, please refer to FIG. 2. In this embodiment, in step S105, the computing unit 100 trains a language model of the extended language by the extended language text file of the extended language. The language model can be regarded as including the probability that words form a meaningful phrase in a language.

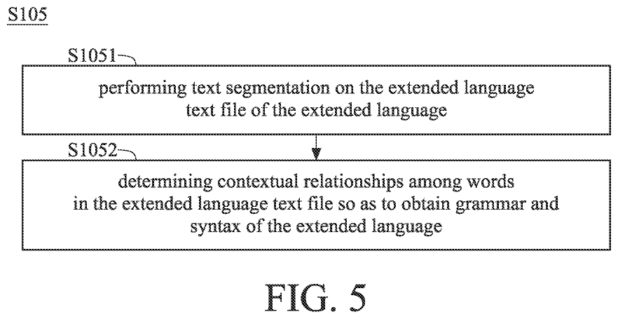

Specifically, please refer to FIG. 5, which is a partial detailed flow chart of the method of training the speech recognition model of the extended language by speech in the source language in FIG. 2. In this and some embodiments, in step S1051, the input unit 200 receives a semantic interpretation instruction, such that the computing unit 100 is able to perform text segmentation on the extended language text file of the extended language. The semantic interpretation instruction may be generated by a corpus system (not shown). In step S1052, the computing unit 100 determines contextual relationships among words in the extended language text file so as to obtain grammar and syntax of the extended language, wherein the contextual relationships among words may include the probability of one of the words existing before or after another of the words (i.e., the grammatical arrangement of words).

Then, please refer to FIG. 2. In this embodiment, the computing unit 100 already determines the probability that speech in each record from the extended language belongs to one or more specific phoneme sequences from the source language and correspondingly belongs to one or more specific symbol sequences from the extended language in step S104 of training the acoustic model, and the computing unit 100 already obtains grammar and syntax of the extended language in step S105 of training the language model. As such, in step S106, the computing unit 100 is able to use the acoustic model of the extended language and the language model of the extended language to create a speech recognition model of the extended language. More particularly, the computing unit 100 may create the speech recognition model of the extended language by combining the acoustic model of the extended language and the language model of the extended language. In other words, the speech recognition model of the extended language includes the acoustic model and the language model of the extended language. Accordingly, when the input unit 200 receives a voice record of the extended language, the computing unit 100 is able to determine that the voice record belongs to one or more symbol sequences through the acoustic model, and then to determine that the one or more symbol sequences belong to a word sequence as a speech-recognized result, so that the computing unit 100 is able to transmit the speech-recognized result to the output unit 400 to display the speech-recognized result.

In the abovementioned steps, the speech recognition model of the extended language can be trained by a speech corpus of the source language without collecting speech of the extended language. Accordingly, the acoustic model of the source language can be used for the extended language, especially for a language with a small number of speakers, at low cost by transfer learning, which may simplify the training process and reduce the training cost, so that the speech recognition model of the extended language can be trained quickly and easily.

In addition, a language model of the source language or another extended language can be included into the storage unit 300, such that the computing unit 100 is able to achieve a function of only using an acoustic model of a single language (the source language) to train a speech recognition model of multiple languages (the source language and the extended language, or the extended language and the another extended language).

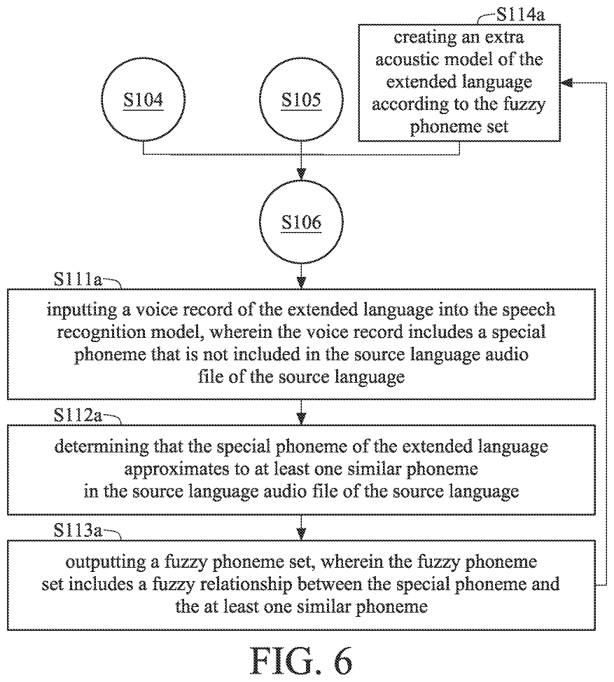

Please refer to FIG. 6, which is a partial detailed flow chart of a method of training a speech recognition model of an extended language by speech in a source language according to another embodiment of the present disclosure. In step S111a, the input unit 200 inputs a voice record of the extended language into the speech recognition model, wherein the voice record may be from, for example, a speech corpus of the extended language and includes a special phoneme that is not included in the source language audio file of the source language. Then, in step S112a, the computing unit 100 determines that the special phoneme of the extended language approximates to at least one similar phoneme in the source language audio file of the source language. For example, the computing unit 100 determines that “f” from Taiwanese Hakka approximates to “p” from South Korean Standard Language. In step S113a, the computing unit 100 outputs a fuzzy phoneme set to the storage unit 300 to store the fuzzy phoneme set in the storage unit 300, wherein the fuzzy phoneme set includes a fuzzy relationship between the special phoneme (e.g., “f”) and the at least one similar phoneme (e.g., “p”). In step S114a, the computing unit 100 creates an extra acoustic model of the extended language according to the fuzzy phoneme set. Then the computing unit 100 is able to update the speech recognition model of the extended language according to the extra acoustic model, thereby reducing the possibility of speech misrecognition resulting from a special pronunciation of the extended language not being included in the source language and its corresponding special symbol not being included in the extended language text file obtained in step S102.

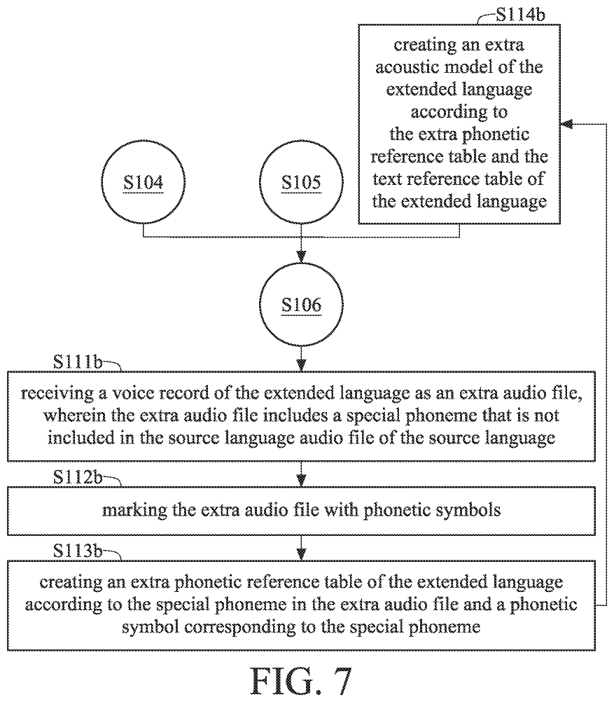

Please refer to FIG. 7, which is a partial detailed flow chart of a method of training a speech recognition model of an extended language by speech in a source language according to further another embodiment of the present disclosure. In step S111b, the input unit 200 receives a voice record of the extended language, such that the computing unit 100 is able to record and store the voice record in the storage unit 300 as an extra audio file, wherein the extra audio file may be from, for example, a speech corpus of the extended language and includes a special phoneme that is not included in the source language audio file of the source language. For example, the input unit 200 receives a voice record including the pronunciation of “f” from Taiwanese Hakka as an extra audio file that accommodates for the lack of the pronunciation of “f” from South Korean Standard Language. Then in step S112b, the input unit 200 receives another mark instruction, such that the computing unit 100 is able to mark the extra audio file with phonetic symbols. The another mark instruction may be generated by a phoneme recognition system (not shown). In step S113b, the computing unit 100 creates an extra phonetic reference table of the extended language according to the special phoneme in the extra audio file and a phonetic symbol corresponding to the special phoneme. In step S114b, the computing unit 100 creates an extra acoustic model of the extended language according to the extra phonetic reference table and the text reference table of the extended language. Then the computing unit 100 is able to update the speech recognition model of the extended language according to the extra acoustic model, so that the speech recognition model is able to use the recorded special phoneme to reduce the possibility of speech misrecognition for the consideration of speech misrecognition.

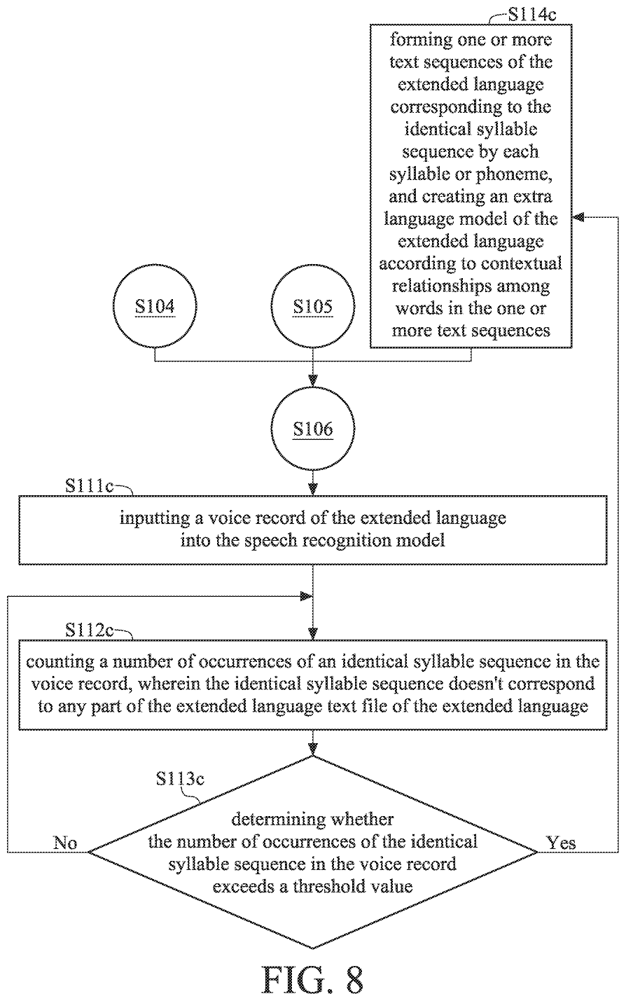

In addition, please refer to FIG. 8, which is a partial detailed flow chart of a method of training a speech recognition model of an extended language by speech in a source language according to still further another embodiment of the present disclosure. In step S111c, the input unit 200 inputs a voice record of the extended language into the speech recognition model. Then in step S112c, the computing unit 100 counts a number of occurrences of an identical syllable sequence in the voice record, wherein the identical syllable sequence doesn't correspond to any part of the extended language text file of the extended language. For example, new vocabulary may be created due to the development of technology, and the new vocabulary can be considered as a syllable sequence that doesn't correspond to any part of the extended language text file. In step S113c, when the computing unit 100 determines that the number of occurrences of the identical syllable sequence (e.g., new vocabulary) in the voice record exceeds a threshold value, step S114c is performed. In step S114c, the computing unit 100 forms one or more text sequences of the extended language corresponding to the identical syllable sequence by each syllable or phoneme and creates an extra language model of the extended language according to contextual relationships among words in the one or more text sequences. Then the computing unit 100 is able to update the speech recognition model of the extended language according to the extra language model, thereby improving recognition efficiency of the speech recognition model when receiving speech including new vocabulary of the extended language.

In view of the above statement, the speech recognition model of the extended language can be trained by a speech corpus of the source language without collecting speech of the extended language. Accordingly, the acoustic model of the source language can be used for the extended language, especially for a language with a small number of speakers, at low cost by transfer learning, which may simplify the training process and reduce the training cost, so that the speech recognition model of the extended language can be trained quickly and easily.

The embodiments are chosen and described in order to best explain the principles of the present disclosure and its practical applications, to thereby enable others skilled in the art best utilize the present disclosure and various embodiments with various modifications as are suited to the particular use being contemplated. It is intended that the scope of the present disclosure is defined by the following claims and their equivalents.

What is claimed is:

1. A method of training a speech recognition model of an extended language by speech in a source language, comprising:
creating a phonetic reference table of the source language, wherein the phonetic reference table comprises a source language audio file and a source language phonetic transcription that correspond to each other;
obtaining an extended language text file of the extended language;
according to a mark instruction, marking the extended language text file with an extended language phonetic transcription so as to create a text reference table of the extended language;
training an acoustic model of the extended language by the phonetic reference table of the source language and the text reference table of the extended language; and
training a language model of the extended language by the extended language text file of the extended language;
wherein the speech recognition model of the extended language comprises the acoustic model and the language model of the extended language.

2. The method of training the speech recognition model of the extended language by speech in the source language according to claim 1, wherein training the acoustic model of the extended language comprises:
obtaining a relationship between phonemes in the source language audio file and symbols in the source language phonetic transcription of the source language; and
determining a probability of a symbol sequence in the extended language phonetic transcription corresponding to a phoneme sequence in the source language audio file according to whether the extended language phonetic transcription of the extended language is identical to the source language phonetic transcription of the source language.

3. The method of training the speech recognition model of the extended language by speech in the source language according to claim 2, wherein determining the probability of the symbol sequence in the extended language phonetic transcription corresponding to the phoneme sequence in the source language audio file comprises:
when a symbol sequence of a word in the extended language phonetic transcription of the extended language is identical to a symbol sequence in the source language phonetic transcription corresponding to a record in the source language audio file of the source language, determining that each frame of a phoneme sequence of the record in the source language audio file of the source language equals to the symbol sequence of the word in the extended language phonetic transcription of the extended language; and
outputting an equal relationship between the phoneme sequence of the record and the symbol sequence of the word.

4. The method of training the speech recognition model of the extended language by speech in the source language according to claim 2, wherein determining the probability of the symbol sequence in the extended language phonetic transcription corresponding to the phoneme sequence in the source language audio file comprises:
when a symbol sequence of a part of a word in the extended language phonetic transcription of the extended language is identical to a symbol sequence in the source language phonetic transcription corresponding to a syllable in the source language audio file of the source language, determining that each frame of a phoneme sequence of the syllable in the source language audio file of the source language equals to the symbol sequence of the part of the word in the extended language phonetic transcription of the extended language; and
outputting an equal relationship between the phoneme sequence of the syllable and the symbol sequence of the part of the word.

5. The method of training the speech recognition model of the extended language by speech in the source language according to claim 2, wherein determining the probability of the symbol sequence in the extended language phonetic transcription corresponding to the phoneme sequence in the source language audio file comprises:
when a vowel or a consonant in the extended language phonetic transcription of the extended language is identical to a symbol in the source language phonetic transcription corresponding to a phoneme in the source language audio file of the source language, determining that the phoneme in the source language audio file of the source language equals to the vowel or the consonant in the extended language phonetic transcription of the extended language; and
outputting an equal relationship between the phoneme and the vowel or the consonant.

6. The method of training the speech recognition model of the extended language by speech in the source language according to claim 2, wherein determining the probability of the symbol sequence in the extended language phonetic transcription corresponding to the phoneme sequence in the source language audio file comprises:
when a special symbol in the extended language phonetic transcription of the extended language is different from any symbol in the source language phonetic transcription of the source language, determining that the special symbol in the extended language phonetic transcription of the extended language approximates to at least one similar phoneme in the source language audio file of the source language; and
outputting a fuzzy phoneme set, wherein the fuzzy phoneme set comprises a relationship between the special symbol and the at least one similar phoneme.

7. The method of training the speech recognition model of the extended language by speech in the source language according to claim 1, wherein training the language model of the extended language comprises:
performing text segmentation on the extended language text file of the extended language; and
determining contextual relationships among words in the extended language text file.

8. The method of training the speech recognition model of the extended language by speech in the source language according to claim 1, further comprising:
inputting a voice record of the extended language into the speech recognition model, wherein the voice record comprises a special phoneme that is not included in the source language audio file of the source language;
determining that the special phoneme approximates to at least one similar phoneme in the source language audio file;
outputting a fuzzy phoneme set, wherein the fuzzy phoneme set comprises a relationship between the special phoneme and the at least one similar phoneme;
creating an extra acoustic model of the extended language according to the fuzzy phoneme set; and
updating the speech recognition model of the extended language according to the extra acoustic model.

9. The method of training the speech recognition model of the extended language by speech in the source language according to claim 1, further comprising:
receiving a voice record of the extended language as an extra audio file, wherein the extra audio file comprises a special phoneme that is not included in the source language audio file of the source language;
according to a mark instruction, marking the extra audio file with phonetic symbols;
creating an extra phonetic reference table of the extended language according to the special phoneme and a phonetic symbol corresponding to the special phoneme;
creating an extra acoustic model of the extended language according to the extra phonetic reference table and the text reference table of the extended language; and
updating the speech recognition model of the extended language according to the extra acoustic model.

10. The method of training the speech recognition model of the extended language by speech in the source language according to claim 1, further comprising:
inputting a voice record of the extended language into the speech recognition model;
counting a number of occurrences of an identical syllable sequence in the voice record, wherein the identical syllable sequence doesn't correspond to any part of the extended language text file of the extended language;
when the number of occurrences of the identical syllable sequence in the voice record exceeds a threshold value, recording a text sequence of the extended language that corresponds to the identical syllable sequence so as to create an extra language model according to the text sequence; and
updating the speech recognition model of the extended language according to the extra language model.

11. The method of training the speech recognition model of the extended language by speech in the source language according to claim 1, wherein the source language audio file of the source language comprises pronunciation of multiple people.

12. The method of training the speech recognition model of the extended language by speech in the source language according to claim 1, wherein creating the phonetic reference table of the source language comprises: using at least one vowel and at least one consonant in the source language phonetic transcription to represent the source language, without tone letters;
wherein marking the extended language text file to create the text reference table of the extended language comprises: using at least one vowel and at least one consonant in the extended language phonetic transcription to represent the extended language, without tone letters.

13. The method of training the speech recognition model of the extended language by speech in the source language according to claim 12, wherein the at least one vowel and the at least one consonant are based on Roman script.

14. The method of training the speech recognition model of the extended language by speech in the source language according to claim 12, wherein the at least one vowel and the at least one consonant are based on International Phonetic Alphabet.
